(19) United States
(12) Patent Application Publication
(10) Pub. No.: US 2017/0015080 A1
(43) Pub. Date: Jan. 19, 2017

(54) METHOD OF MAKING AN INSULATED MAILER

(71) Applicant: MP Global Products, L.L.C., Norfolk, NE (US)

(72) Inventors: Chad A. Collison, Pierce, NE (US); Alan B. Collison, Pierce, NE (US)

(21) Appl. No.: 15/211,358

(22) Filed: Jul. 15, 2016

Related U.S. Application Data
(60) Provisional application No. 62/192,717, filed on Jul. 15, 2015.

(51) Int. Cl. B31B 41/00; B31D 5/00; B31B 1/64; B31B 1/68; B31B 7/00; B31B 1/62

(52) U.S. Cl. CPC B31B 41/00; B31B 7/00; B31B 1/62; B31B 1/64; B31B 1/68; B31D 5/0004; B31D 5/0039; B31B 2219/6007; B31B 2219/603; B31B 2219/6084; B31B 2219/90; B31B 2221/05

(57) ABSTRACT

A method and system for producing an insulated mailer having an insulative textile pad substructure with a density of greater than 10 pounds per cubic foot is provided. The insulative textile pad has entangled reinforcement fibers.

This application claims the benefit of U.S. Provisional Application No. 62/192,717, filed on Jul. 15, 2015. The entire disclosure of the above application is incorporated herein by reference. The present invention relates to the method and system for producing an envelope and more particularly to method and system for producing an insulated mailer.

### FIELD

### Background

Insulated shipping containers (envelopes and boxes) are widely used in many shipping applications. An insulated shipping container is desirable when shipping materials which need to be shipped at a reduced or elevated temperatures. Similarly, shipping container are desirable when shipping materials which need to avoid large temperature swings. They may also provide impact deadening that may lessen impact stresses on the product being shipped to lengthen the life of the product being shipped and make the product being shipped appear to be more durable and of a higher quality. What is needed, therefore, are improvements in methods and apparatus for forming insulated envelops.

### SUMMARY

This section provides a general summary of the disclosure, and is not a comprehensive disclosure of its full scope or all of its features.

The method and system for producing of an insulated mailer according to the present teachings included placing loose fibrous material onto a moving conveyor. The fibers in the fibrous material can be interlocked by methods such a needling or by use of a melted binder fiber. The fibrous material is formed into a slab by passing the continuous layer of material between a pair of tapered edge plates which forms the batt width. The thickness of the uncompressed slab can be defined by an upper rake or block. This material can have its thickness and density adjusted using a compression roller and the application of setting heat. In this regard, the insulative material can

After compression, the batt can then be cut into individual pieces using a slicing knife. Optionally, the batt can be cut in half along its thickness using a moving slicing knife or blade. This allows for a more controllable insulative pad density. Once the batt is formed into a rectangular shape and thickness, the material is then ready for coupling to an inner polymer film layer.

The inner polymer film layer is taken off of a roll of appropriate material that can for instance be pre-perforated. The inner polymer film is cut into specific lengths and widths. For example, the inner polymer film can have a width and length larger than the width and length of the fibrous batt. The inner film layer is disposed over the batt, overlapping the batt on all four sides. The ends of the film are wrapped about and tucked under the ends of the batt. Heat or adhesive is applied to fix the inner film to the batt.

The inner film is then folded in half placing the batt on an outside surface of the inner film which is disposed against itself. The folded batt is then placed through an end closure apparatus which closed the side of the inner film, thus forming a pocket. The edges can be sewn shut using an industrial sewing machine.

An outer polymer sheet can then be positioned about the outside of the folded batt layer. The outside envelope polymer layer can be positioned about the batt on inner polymer layer in a manner which forms a closable flap. This closable flap can take an adhesive in the form of dual sided tape.

The outer polymer layer is then coupled to the inner polymer layer, encapsulating the insulative material between the inner and outer barrier. In this regard, the edge of the outer layer can be coupled to the inner layer using heat, adhesive, or stitching. Excess material along the edges can be removed.

According to the present teachings, a system for forming a tri-insulated fold box liner is provided. The system includes a plurality of linked conveyors configured to move an insulated pad a series of processes to form the tri-fold box liner. A cutting apparatus associated with the conveyor is provided to the separate insulated pad from a continuous batt. A series of roller configured to position an upper film and a lower film about the insulated pad. An apparatus configured to position an upper film layer and a lower film layer from the continuous film supply on opposite sides of the insulated pad. A means for cutting and sealing the edges of the upper and lower films about the insulated pad is proved.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents the formation of a insulative pad for an insulative mailer;

FIG. 2 represents positioning a film over the insulative pad shown in FIG. 1;

FIG. 3 represents the cutting of the film positioned over the pad as shown in FIG. 2;

FIG. 4 represents positioning the film about the edges of the pad;

FIG. 5 represents the application of heat to bind the barrier film to the pad;

FIG. 6 represents folding the construction of FIG. 5 into a pocket;

FIG. 7 represents sewing the sides of the construction of FIG. 6 to form a pocket;

FIG. 8 represents the application of an adhesive;

FIG. 9 represents the application of an outer film about the construction of FIG. 8;

FIG. 10 represents heat sealing and cutting the inner and outer film of the constructions of FIG. 9;

FIG. 11 represents the mailer formed using the methods and systems of FIGS. 1-10;

FIG. 12 represents a system to form a box liner line according to another teaching of the present teachings;

FIGS. 13a-13b represent the cutting of and formation of an insulative pad;

FIGS. 14a-14c represent the application of an upper barrier film according to the present teachings;

FIGS. 15a-15b represents the application of a bottom barrier film;

FIGS. 16a and 16b represent side sealing of the films about the insulative member; and

FIG. 17 represents the heat shrink tunnel used to form the box insulative member according to the present teachings.

Corresponding reference numerals indicate corresponding parts throughout the several views of the drawings.

### DETAILED DESCRIPTION

Example embodiments will now be described more fully with reference to the accompanying drawings.

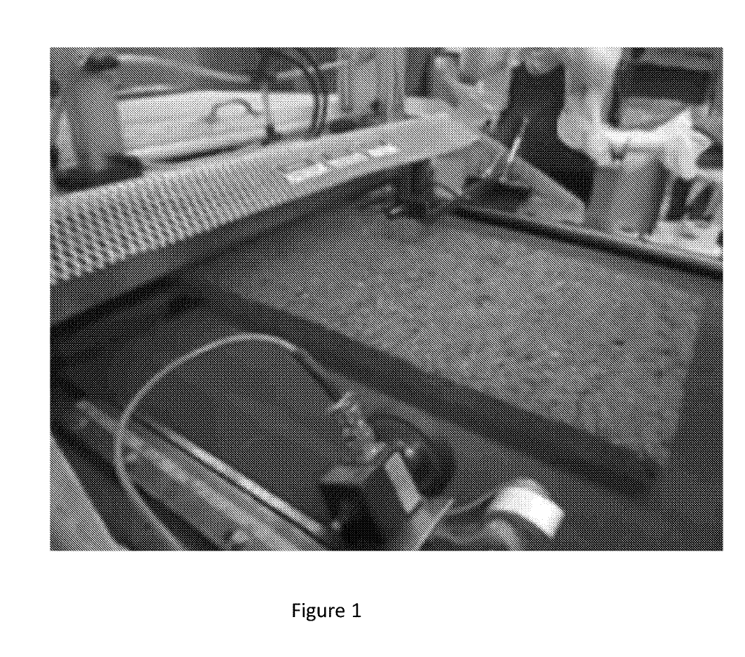

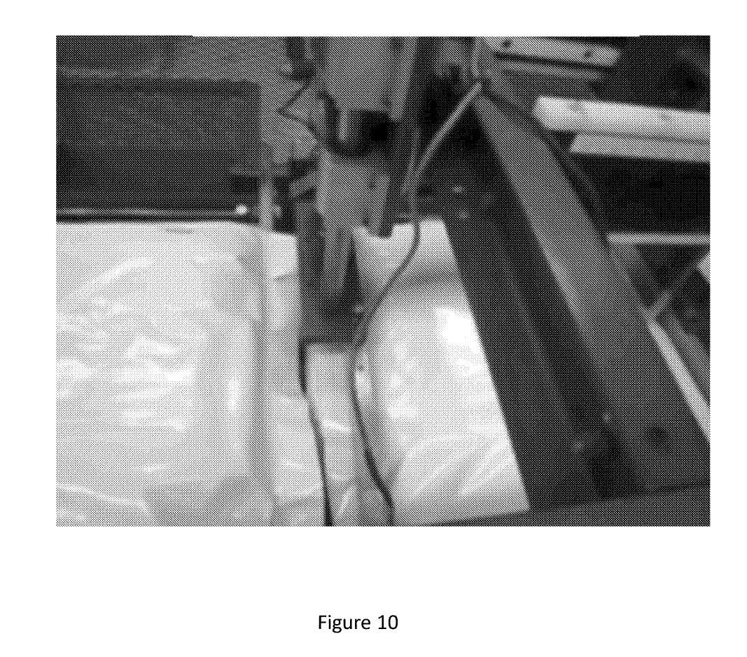

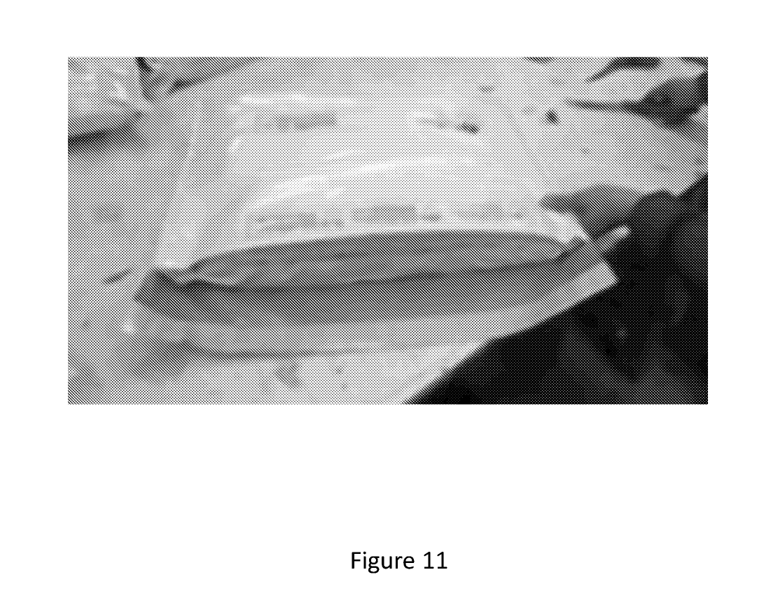

The formation of an insulated mailer will be described in the description of FIGS. 1-12. As shown in FIG. 1, fibrous material is placed onto a moving conveyor. The fibers can be interlocked by methods such a needling or by use of a melted binder The fibrous material is formed into a slab 10 by passing the continuous layer of material between a pair of tapered edge plates 12 which forms the batt width. The thickness of the uncompressed slab can be defined by an upper rake or block 14. This material can then have its thickness and density adjusted using a compression roller 16.

The insulative material is continuously fed on a conveyor between a pair of side guides which define a pair of sides for a continuous strip of insulative material. The side guides define a predetermined width for the pad. One aligned, the continuous strip of material is positioned under a slicing mechanism which cuts the continuous batt into predefined lengths.

The pad is transported via conveyor to a second location where a first polymer film is draped over the pad. The first polymer film has a length and a width larger than the length and width of the pad. First and Second ends of the first film are tucked under first and second ends of the pad.

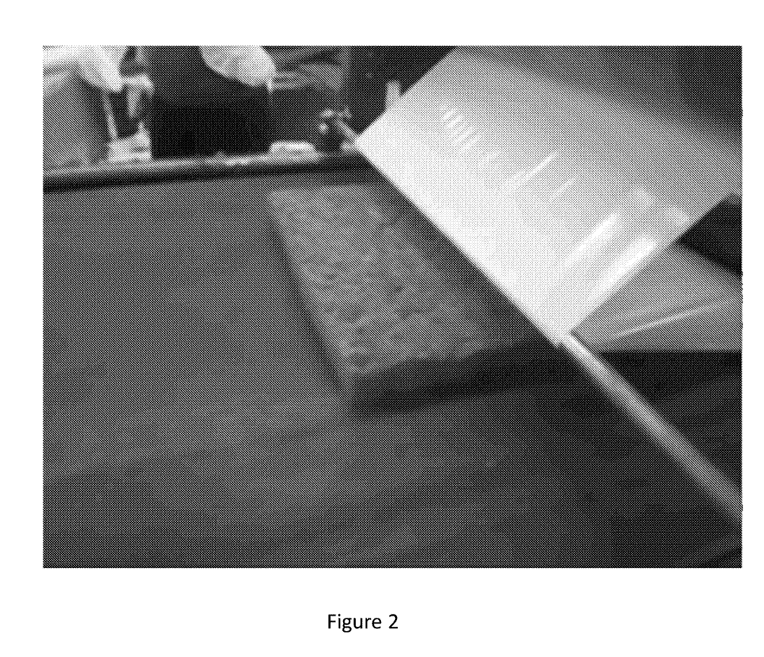

As shown in FIG. 2, the batt can then be cut into individual pieces using a slicing knife which can be a rotating band or circular blade. Optionally the batt can be cut in half along its thickness using a slicing knife. Once the batt is formed into a rectangular shape and thickness, the material is then ready for coupling to an inner polymer film layer.

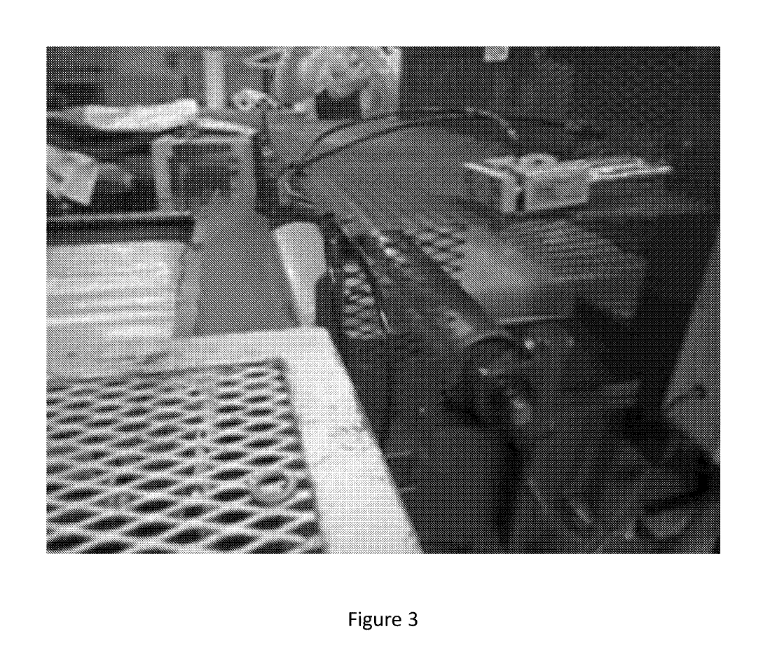

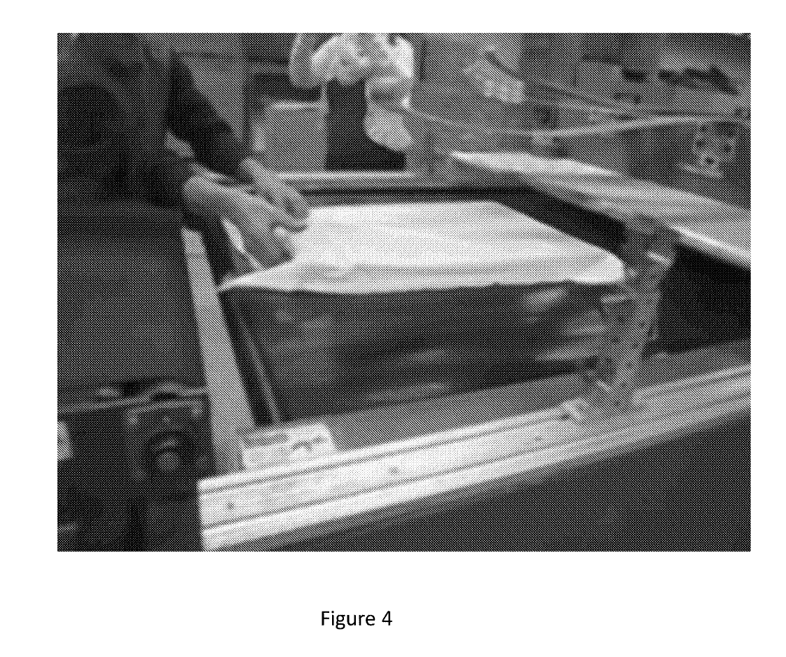

The inner polymer film layer 24 is taken off of a roll of appropriate material that can for instance be pre-perforated. As shown in FIGS. 3 and 4, the inner polymer film is positioned over the insulated layer and is cut into specific lengths and widths. For example, the inner polymer film can have a width and length larger than the width and length of the fibrous batt 22.

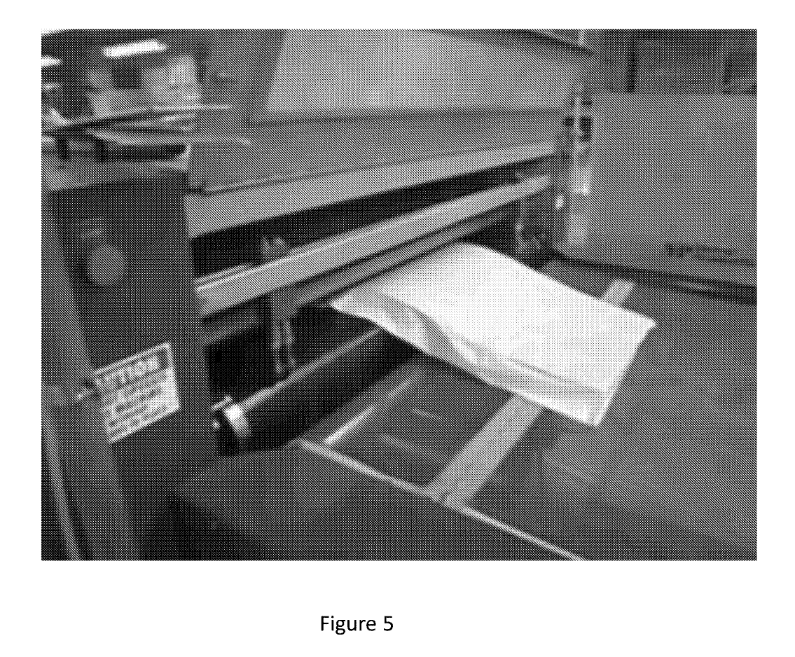

As shown in FIG. 4, the inner film layer 24 is disposed over the batt 22, overlapping the batt 22 on all four sides. The ends 26 of the film are wrapped about and tucked under the ends 28 of the batt 22. As shown in FIG. 5, heat or adhesive can be applied to fix the inner film 24 to the batt 22. The inner film 22 is then folded in half placing the batt on an outside surface of the inner film which is disposed against itself, thus forming a subassembly.

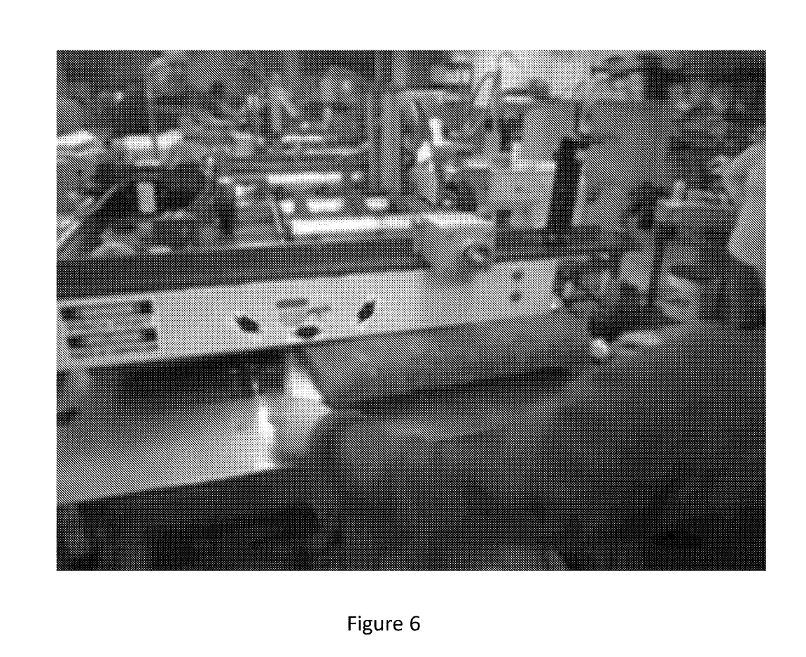

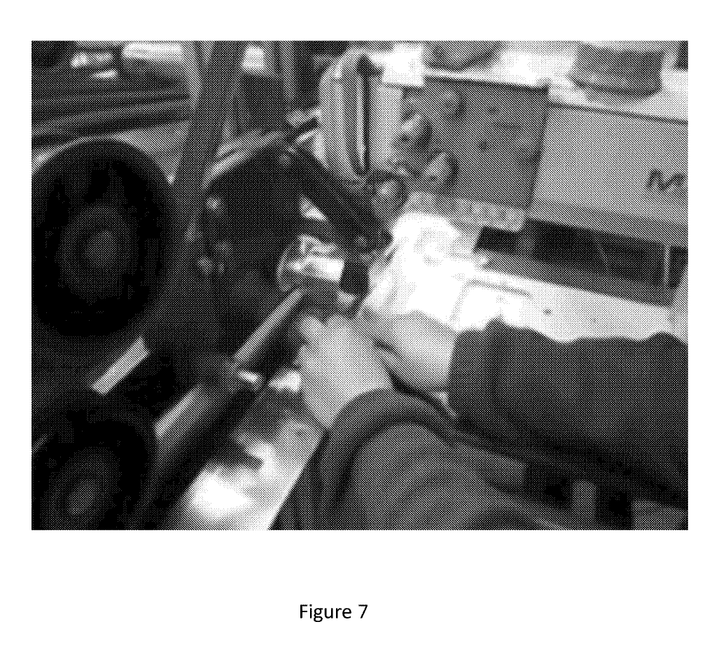

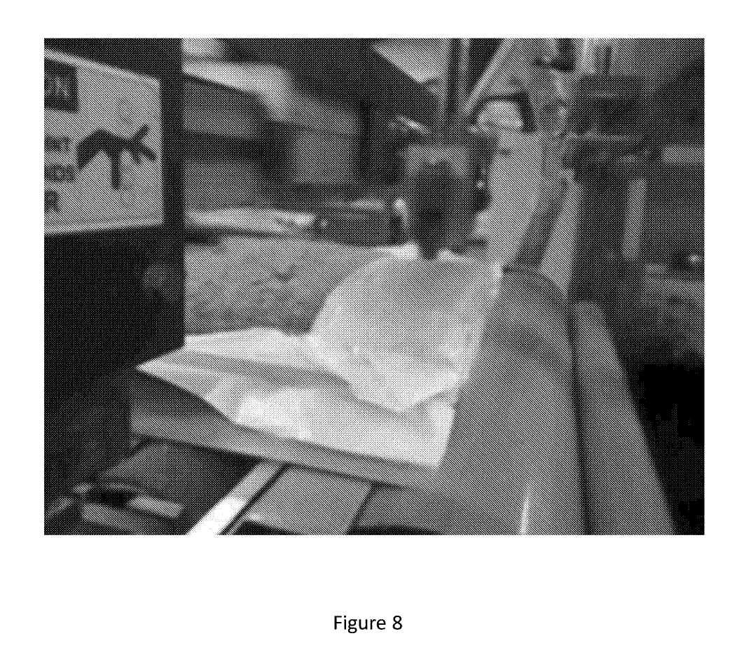

As shown in FIG. 6, the folded batt is then placed through an end closure apparatus which closes the sides of the inner film 24, thus forming a pocket 30. As shown in FIG. 7, the edges can be sewn shut using an industrial sewing machine or can be heat staked as appropriate. A row of smaller stitches 80 extend from top to bottom of the mailer 40 along each side thereof juxtaposed adjacent to the lateral edges 82 of pad 46. Spaced slightly inwardly of stitches 80, is a second row of larger stitches 86 that encompass the pad 46 and the film 44 on the inside of the pad 46 and include the portions 78 on the outside of the pad 46. The second rows of stitches only extend longitudinally from the top of the mailer downwardly and terminate with the portions 78. Apart from the stitching and heat sealing of the film 44 to film 42, pad 46 is not attached to film 42. FIG. 8 represents the application of the adhesive to assist binding an exterior barrier to the interior barrier.

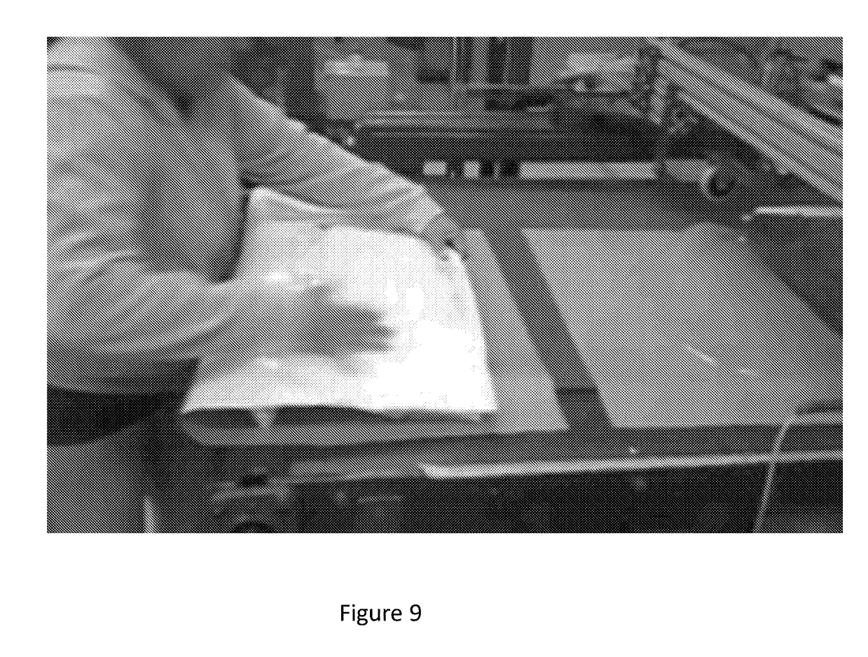

As shown in FIG. 9, the outer polymer sheet 32 can then be positioned about the outside of the folded batt 22. The outside envelope polymer layer 32 can be positioned about the batt 22 on inner polymer layer in a manner which forms a closable flap 56. This closable flap 56 can take an adhesive 36 in the form of dual sided tape.

The outer polymer film 34 is then coupled to the inner polymer film, encapsulating the insulative material or batt 22 between the inner and outer polymer layers. In this regard, the edge of the outer layer can be coupled to the inner layer using heat, adhesive, or stitching. Excess material along the edges can be removed.

The insulative batt 22 can be manufactured from any of a wide variety of textile compositions comprising, for example, polyester, nylon, acrylic, cotton, polypropylene, denim etc., or combinations thereof, including both natural and man-made fibers. Randomly distributed textile and binder fibers having lengths between 1/16 inch to 1.5 inches and a denier of between 5 and 12 are used to form a textile batt 22, which is processed to form the insulative pad 46.

The outer surface of the mailer 40 can consist of a non-petroleum based, biodegradable film or paper 42 that is also waterproof. Optionally, the film 42 extends laterally so its lateral edges or margins 44 can be heat sealed together. At the bottom of the mailer the film 42 is folded at 52. At the top of the mailer the front top edge 58 terminates at the mailer opening 54, and the back continues upwardly to form flap 56 to enable the mailer 40 to be sealed by folding the flap 56 over the front of the mailer closing off the opening 54. The flap 56 has a lateral stripe of adhesive 30 covered with a removable protecting paper 62.

The inner surface of the mailer 40 can be a non-petroleum based, biodegradable film or paper (substrate) 44 that is permeable. Sandwiched between the inner biodegradable film or paper (substrate) 44 and the outer film 42, and sealed on all sides, is a proprietary, biodegradable pad 46 made from re-cycled, purified, ground-up material to which super absorbent powders (for the absorption of spills), and antimicrobial powders (for the prevention of contamination in case of rupture for such products as blood or vaccines, etc.) have been added during manufacture. The antimicrobials are programmed to expire, after a pre-selected desired length of time, to allow for the eventual, natural, degradation/biodegradability of the mailer. The outer surface of the pad 16 is encompassed within the water-proof, biodegradable film or paper 42, sealed on two (or three) sides with film 44, which extends laterally coextensive with film 12. The film 44 is double-sealed with pressure-sensitive, biodegradable tape 18 (covered with a protective strip 64, at the top, for safety and to prevent tampering). Film 44 does not surround the pad 46 completely, but the end portions 70 extend around the pad 46 sufficiently to enable the end portions 70 to be sealed with the film 42, as indicated at 44.

As evident from the above description, the pad 46 is covered by the film 44 on the inside with film 44 extending laterally beyond the pad 46 to lie coextensive with the marginal edges of the film 42 so all marginal edges can be heat sealed together. Film 44 extends around the longitudinal extremities of the pad 46 so that the end portions 80 of the film 44 lie between the pad 46 and the outer film 42 when the pad 46 is located in the mailer 40. These portions 70 enable the film 44 to be heat sealed together with the film 42 around the mailer opening 54, thereby entrapping the pad 46. The portion of the opening 24 that lies with the flap 56 has pressure-sensitive, biodegradable tape 58 (covered with a protective strip 64) in order to seal the top edges of the inner film 44 together before the flap 56 is sealed to the front of the mailer 40.

Each partial thickness pad 90′ and 90 may be of equal thickness (i.e., the textile insulative pad is split in half), or may be of unequal thickness′. The present invention is capable of forming a partial thickness batt of about 1/16 of an inch or greater. The starting insulative pad 46 may be split longitudinally to provide two, three or more partial thickness batts.

The thermoplastic binder fibers and reinforcement fibers are laid randomly yet consistently in x-y-z axes. The reinforcement fibers are generally bound together by heating the binder fibers above their glass transition temperature. Typically, less than about 20% by weight binder fiber is used, and preferably about 15% binder fiber is used to form the insulative pad 46.

Thermoplastic binder fibers are provided having a weight of less than 0.2 pounds per square foot and, more particularly, preferably about 0.1875 pounds per square foot. The remaining reinforcement fiber is greater than 0.8 pounds per square foot, and preferably 1.0625 pounds per square foot. The binder fibers are preferably a mixture of thermoplastic polymers which consist of polyethylene/polyester or polypropylene/polyester or combinations thereof.

The insulative pad 46 is formed by heating the textile batt 22 in the oven 110 to a temperature greater than about 350° F. and, more preferably, to a temperature of about 362° F. Such heating causes the binder fibers to melt and couple to the non-binder fibers, thus causing fibers to adhere to each other and solidify during cooling. Upon cooling, the binder fibers solidify and function to couple the non-binder reinforcement fibers together as well as function as reinforcement themselves.

The insulative textile batt is compressed to form the insulative pad 22 so it has a density of greater than about 10 pounds per cubic foot. For systems, the insulative pad 46 preferably has a density of greater than about 10 pounds per cubic foot and, more preferably, about 13.3 pounds per cubic foot with a thickness of about ⅛ inch. For insulative pad 46 used under tile, the density is greater than about 15 pounds per cubic foot and, more preferably, about 18.9 pounds per cubic foot.

The insulative pad 46 preferably has a compression resistance at 25% of the original thickness of greater than about 20 psi and preferably about 23.2 psi, at 30% of greater than about 35.0 psi and preferably about 37.0 psi, and at 50% of greater than about 180 psi and preferably about 219 psi. The compression set at a compression of 25% of the original thickness is less than 20% and preferably about 18.8%, and the tensile strength is between about 60 and 80 pounds and, most preferably, about 78.4 pounds.

In the present invention, it has been found that the insulative pad 46 may be controllably and accurately split if the feed rollers 104 are positioned within a predetermined distance from the splitting knife 107. The distance is important because of the compressible and pliable nature of the insulative pad 46. In the preferred embodiment, the predetermined distance is from about zero to about two millimeters.

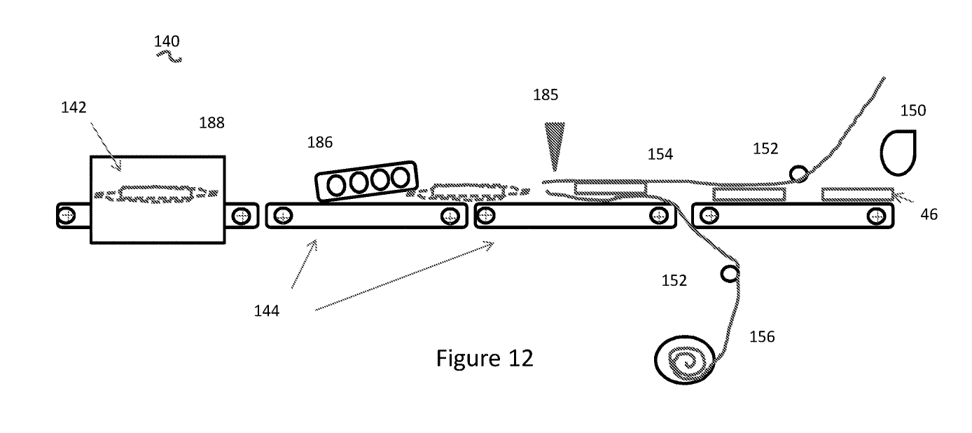

FIG. 12 represents a system 140 to form a tri fold box liner 142 according to another teaching of the present teachings. Generally, the system utilizes a plurality of linked conveyors 144 to move an insulated pad 46 as described above through a series of processes to form the tri-fold box liner 142. The system 140 uses a cutting apparatus 150 to separate insulated pad 46 from a continuous batt 22. A series of roller 152 are then used to position an upper film 154 and a lower film 156 about the insulated pad 46. A second cutting apparatus 185 is used to separate the upper film 154 and a lower film 156 from the continuous film supply. A second sealing and cutting apparatus is used to cut and seal the edges of the upper and lower films about the insulated pad 46. A heat tunnel positioned about a conveyor to shrink the polymer sheet about the insulated pad 46 to form the tri-fold box liner 142.

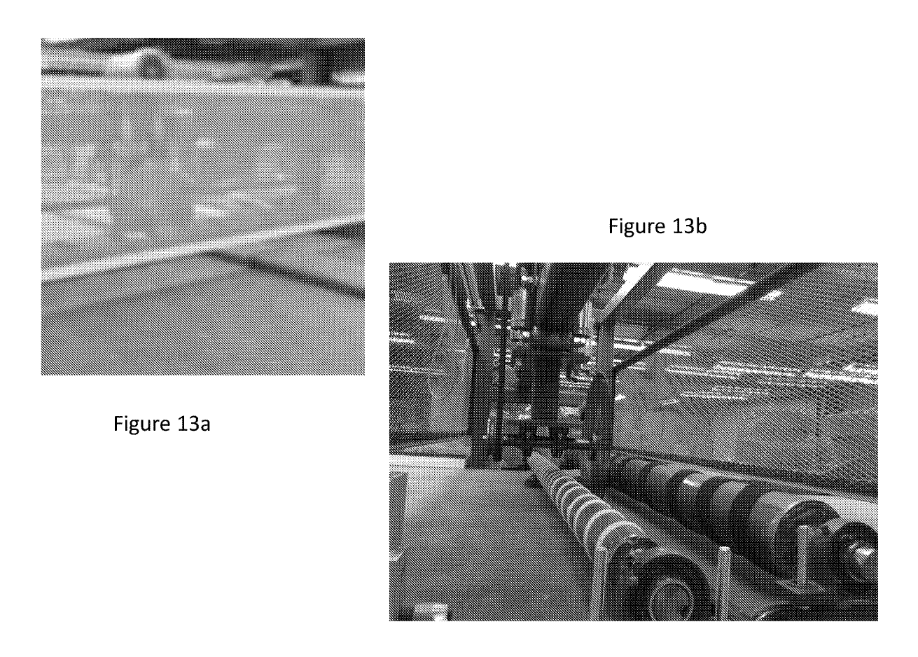

FIGS. 13a-13b represents the cutting of and formation of an insulative pad 46 from the continuous batt 22. As shown, the batt 22 and pad 46 are transported along the plurality of linked conveyors 144. As shown, the cutting apparatus 150 can be a circular blade. Additionally the cutting apparatus can be a belt blade.

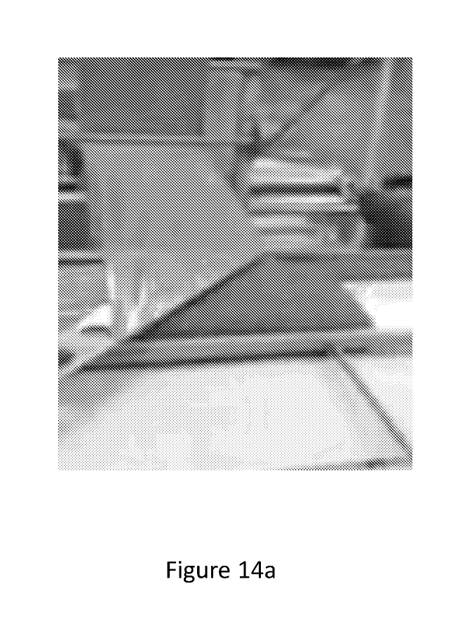

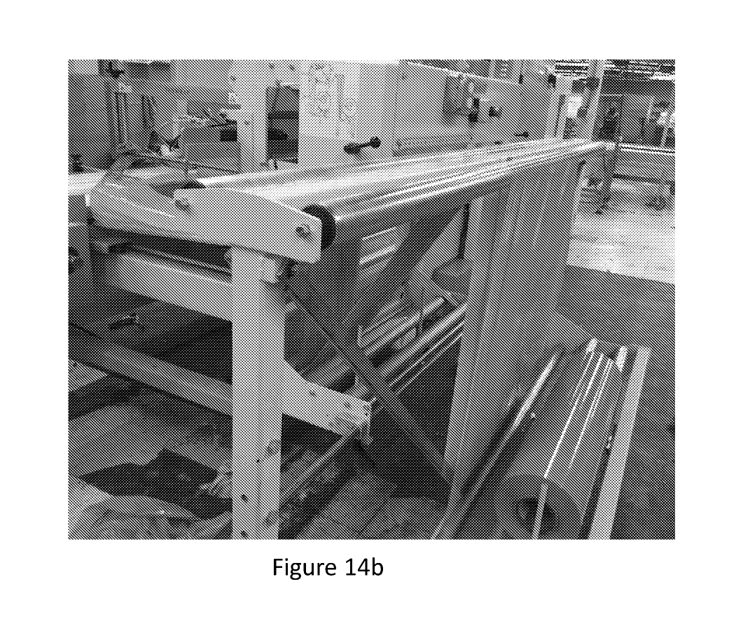

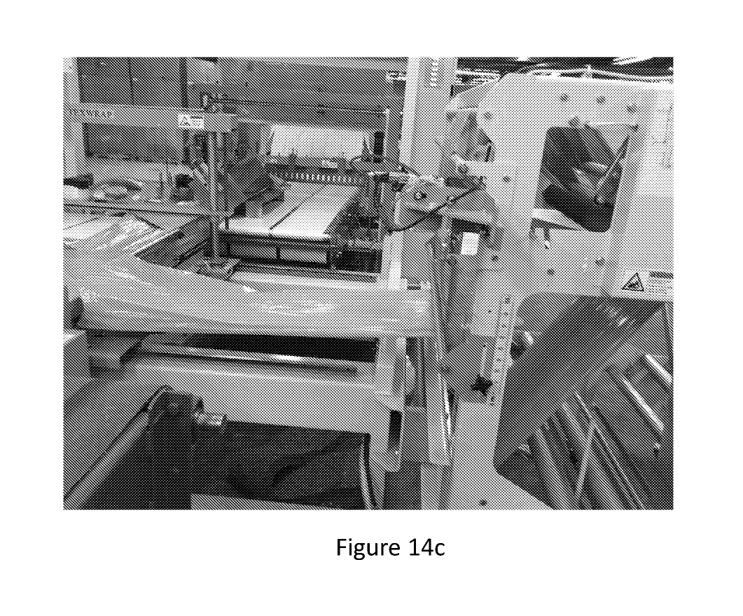

FIGS. 14a-14c represents the application of an upper barrier film according to the present teachings. A series of rollers 152 are then used to position an upper film 154 and a lower film 156 about the insulated pad 46. As shown, the roller 152 can be positioned at an angle which is non-perpendicular to the direction of the moving conveyor. Preferably, this angle can be at 45 degrees to the direction of flow of the conveyor.

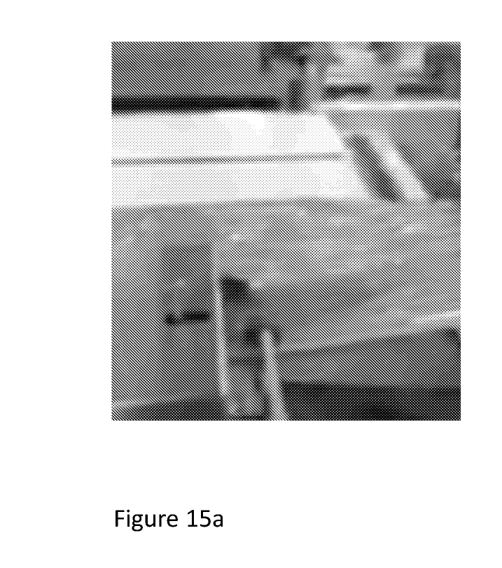

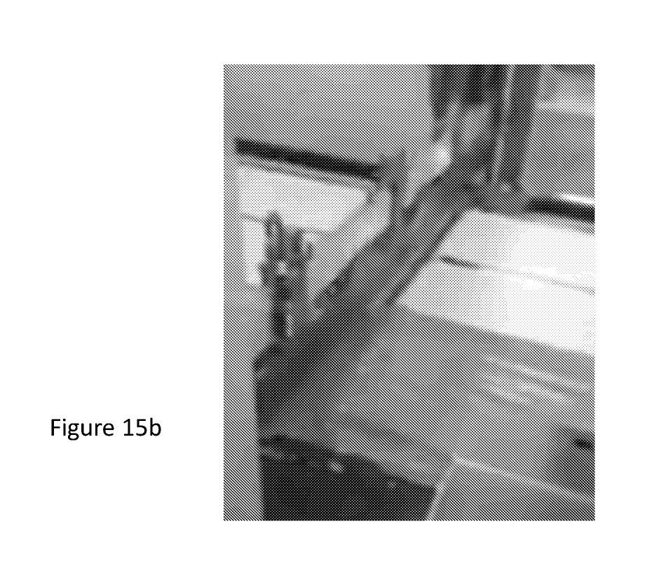

FIGS. 15a-15b represents the application of a bottom barrier film. Once the upper film is positioned above the pad 46, the rollers 152 can position the lower film below the pad 46 at the intersection of two conveyors 144. The second cutting apparatus 185 is used to separate the upper film 154 and a lower film 156 from the continuous film supply.

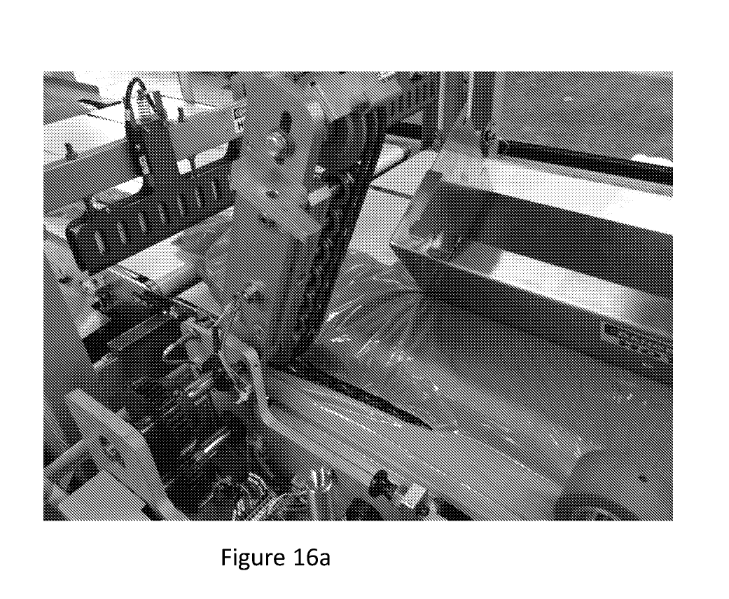

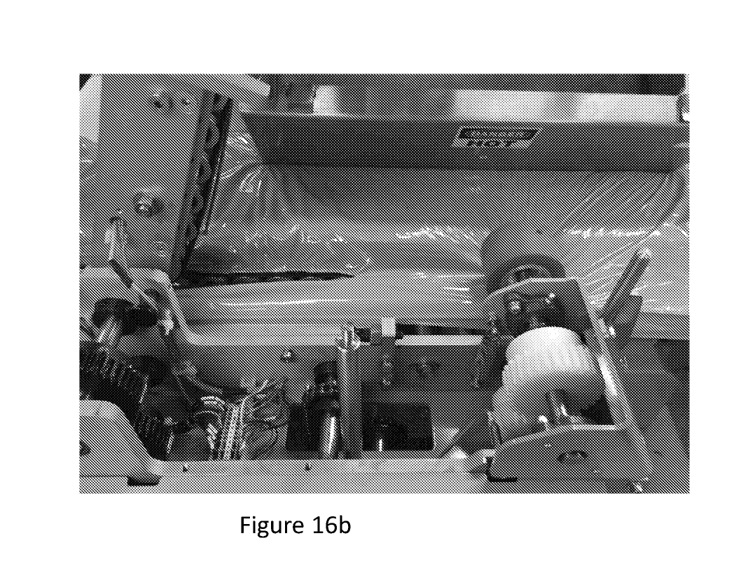

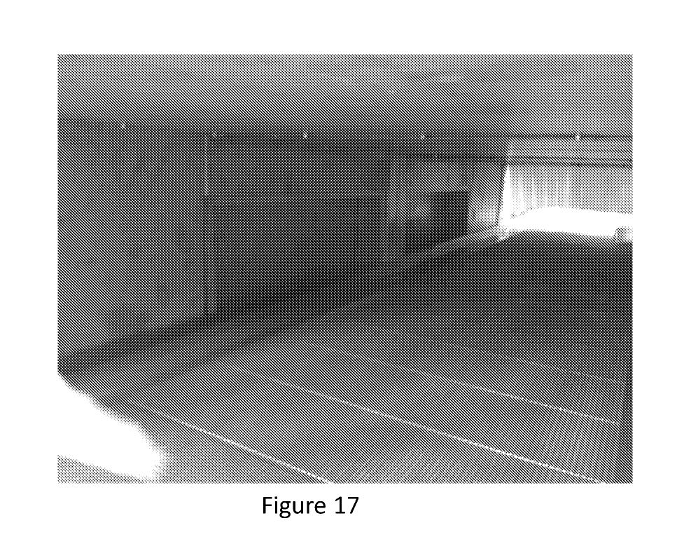

FIGS. 16a and 16b represent side sealing of the films about the insulative member. In this regard a series of cutting and sealing rollers 186 both cut and seal the sides of the tri-fold box liner 142. The cutting and sealing rollers 186 are biased onto the film using a load such as a spring.

FIG. 17 represents the heat shrink tunnel used to form the box insulative member according to the present teachings. Once the construction is sealed on all sides, the subassemble is passed through a heat tunnel which shrinks the upper and lower films about the insulative pad 46 to form the tri-fold box liner 142. The inner and outer film layers 22, 32 can be polymer, a polymer based laminate. When used to form the pad, binder fibers are thermoplastic and are preferably selected from the group containing polyethylene, polyester, polypropylene, and mixtures thereof. The 75 or 100 gauge film can be a Polyolefin based film. The film can be formed using a double bubble extrusion process and/or irradiation process. Optionally, inner dry ice film can be a 3 layer structure mlldpe/HDPE and color/mlldpe at 0.003; the Perforated film 3 layer structure can be a lldpe and color/PA/mlldpe at 0.0015; and the Outer film 3 layer structure can be can be a white outside, silver inside mlldpe and color/LDPE/lldpe and color 0.004.

The film can be in the form of separate upper and lower films positioned over the pad. Additionally, a single film can be folded over the insulative pad or pads along the length of the pads. This would allow for the sealing and trimming of a three sides of the vapor barrier to surround the pads. Additionally, pad materials can be compressed and “shot” into a bag using rotating wheels or rollers.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of forming an insulated envelope comprising:
forming a textile batt and having a first width and first length;
coupling a first film to the textile batt, the first film having a second width and second length larger than the first width and first length;
folding film first and second ends of the first film around first and second ends of the textile batt to form a first subassembly;
folding the first subassembly so that a first portion of the first film is adjacent a second portion of the first film to form a pocket having the textile batt disposed on a subsassembly exterior surface;
disposing a second polymer film over the folded textile batt and about the first pocket; and
coupling the first film to the second polymer film.

2. The method according to claim 1 further comprises forming a flap with the second polymer sheet.

3. The method according to claim 1 wherein coupling the first film to the textile batt comprises one of heating the film and disposing an adhesive between the first film and the batt.

4. The method according to claim 1 further comprises coupling a pair of opposed sides of the first subassembly to form a pocket.

5. The method according to claim 4 wherein coupling a pair of opposed sides of the first subassembly includes one of sewing or adhering with adhesive the pair of opposed sides.

6. A method for producing an insulated envelope comprising:
forming a textile pad having a density of greater than about 10.0 pounds per cubic foot, said textile pad consisting of a fibrous web layer wherein said fibrous web layer comprises reinforcement fibers distributed substantially randomly, said reinforcement fibers being interlocked, wherein after the insulative pad material is compressed to 75% of its original thickness during a compression set test, the material is then capable of returning to more than 80% of its original thickness and has a compression resistance at a compression of 25% of the original thickness of greater than about 20 psi;
disposing a first polymer film adjacent to a first side of the textile pad;
coupling the first polymer film to a first side of the textile pad;
folding first and second ends of the first polymer film around the textile pad;
coupling a second polymer film to a second side of the textile pad covering the first and second ends of the first polymer film; and
coupling the first polymer film to the second polymer film.

7. The method for producing an insulated envelope according to claim 6 further comprising binder fibers selected from the group consisting of polyethylene, polyester, polypropylene, and mixtures thereof.

8. The method according to claim 6 wherein the insulative pad has a density of about 18.9 pounds per cubic foot.

9. The method according to claim 3 wherein the insulative pad is about 3/32 inch thick.

10. The method according to claim 6 wherein the insulative pad has a compression resistance at 50% of the original thickness of greater than about 180 psi.

11. The method according to claim 6 further comprising an adhesive layer disposed between the textile pad and the first polymer film.

12. A method of forming an insulative mailer comprising:
cutting first and second polymer sheets;
coupling a first side of a textile pad to the first polymer sheet, said insulative pad having consisting of a fibrous web distributed substantially randomly, said reinforcement fibers being interlocked, wherein after the insulative pad material is compressed to 75% of its original thickness during a compression set test, the material is then capable of returning to more than 80% of its original thickness;
folding the insulative pad to form a pocket having a first portion of the first polymer sheet disposed adjacent a second portion of the first polymer sheet;
coupling first and second sides of the first polymer sheet to form a pocket;
coupling the second polymer sheet to a second side of the pad; and
coupling the first polymer sheet to the second polymer sheet.

13. The method according to claim 12 further comprising interlocking the binder fibers using needling.

14. The method according to claim 12 wherein the insulative pad has a density of greater than about 13.3 pounds per cubic foot.

15. The method according to claim 12 wherein the insulative pad is about 3/32 inch thick.

16. The method according to claim 12 wherein the insulative pad has a compression resistance at 50% of the original thickness of greater than about 180 psi.

17. A system for forming a tri-fold box liner comprising:
a plurality of linked conveyors configured to move an insulated pad a series of processes to form the tri-fold box liner;
a cutting apparatus to the separate insulated pad from a continuous batt;
a series of roller configured to position an upper film and a lower film about the insulated pad;
an apparatus configured to position an upper film layer and a lower film layer from the continuous film supply on opposite sides of the insulated pad;
a means for cutting and sealing the edges of the upper and lower films about the insulated pad.

18. The system according to claim 17 further including a heat tunnel positioned about a conveyor to shrink the upper and lower layer films about the insulated pad.

19. The system according to claim 17 wherein cutting apparatus is one of a circular blade and a rotating band saw blade.

20. The system according to claim 17 wherein one roller of the series of rollers can be positioned at an angle which is non-perpendicular to a driven direction of the moving conveyor.

21. The system according to claim 20 wherein the angle is about 45 degrees to the direction of flow of the conveyor.

22. The system according to claim 17 wherein the means for cutting and sealing the edges are a plurality of cutting and sealing rollers configured to both cut and seal sides of the tri-fold box liner.

23. The system according to claim 20 wherein the means for cutting and sealing the edges comprises a load such as a spring.
